(19) United States
(12) Patent Application Publication
(10) Pub. No.: US 2011/0036455 A1
(43) Pub. Date: Feb. 17, 2011

(54) LOG SPLITTER

(76) Inventor: Charlie Valdez, Selma, OR (US)

Correspondence Address: KLAAS, LAW, O''MEARA & MALKIN, P.C., 1999 BROADWAY, SUITE 2225, DENVER, CO, 80202, US

(21) Appl. No.: 12/541,845

(22) Filed: Aug. 14, 2009

(51) Int. Cl. B27L 7/06

(52) U.S. Cl. 144/4.6; 144/195.9; 144/195.8

(57) ABSTRACT

Log splitters are disclosed herein. An embodiment of a log splitter comprises a first stage that includes a first port. The first port includes a first port first end and a first port second end, wherein logs enter the first port first end and exit the first port second. A first blade is located on at least a portion of the first port first end, the first blade having a first surface and a second surface, wherein a plane of the first surface and a plane of the second surface intersect proximate the first port first end. The first surface is substantially parallel to the direction of logs through the first port.

### BACKGROUND

Wood provides an efficient fuel for heat. However, logs need to be split in order to burned efficiently. A split log is able to dry and provides a better surface for burning. Log splitting can be very difficult. For example, knots in the logs and trees with twisted grains do not split well using many conventional splitting methods.

### BRIEF DESCRIPTION OF THE DRAWINGS

FIG. 1 is a top perspective view of an embodiment of a log splitter.

FIG. 2 is a perspective view of the first stage of the log splitter of FIG. 1.

FIG. 3 is a perspective view of the second stage of the log splitter of FIG. 1.

### DETAILED DESCRIPTION

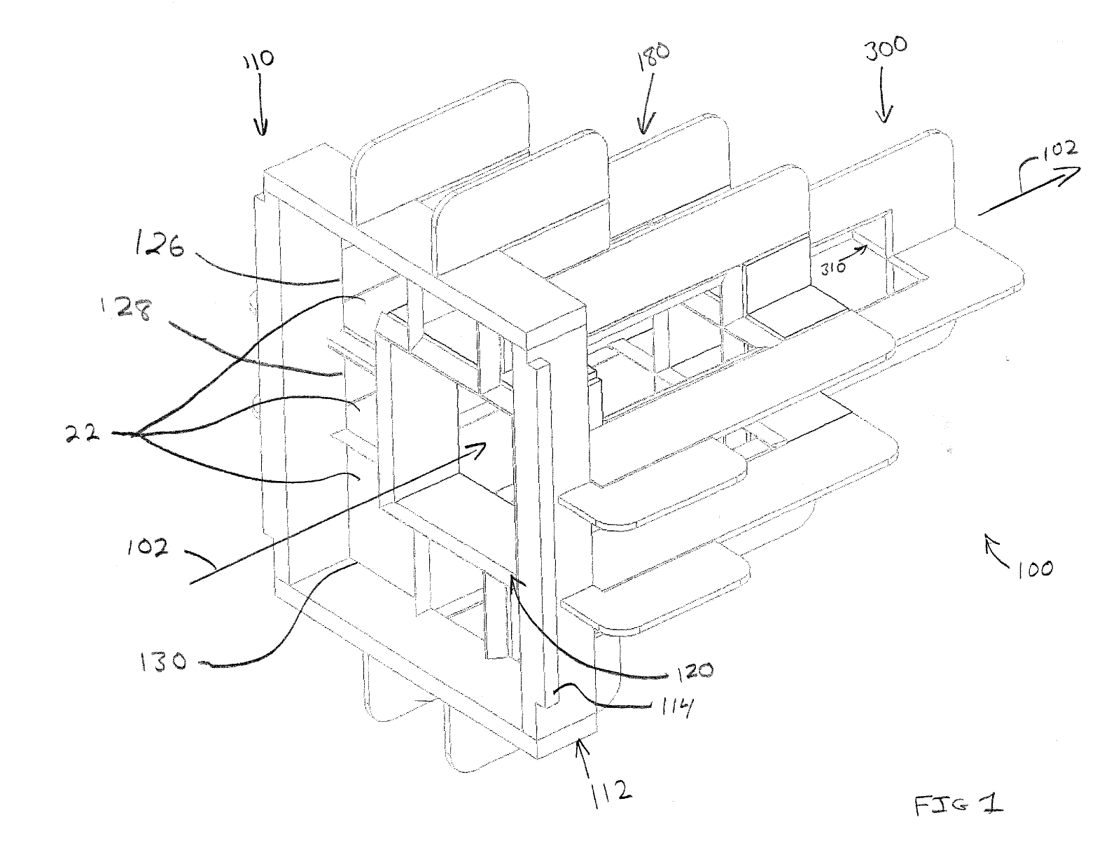

A top perspective view of a log splitter 100 is shown in FIG. 1. As described in greater detail below, the log splitter 100 has a plurality of stages that split a log as the log is forced through the log splitter 100. Logs are forced in a direction 102 through the log splitter 100. The logs get split into smaller and smaller portions as they are forced through the stages. It is noted that other components that serve to force the log through the log splitter 100 may be included or associated with the log splitter, but they are not shown in FIG. 1. For example, a hydraulic ram or the like may force logs through the log splitter 100.

Reference is made to a first stage 110 of the log splitter 100. The first stage 110 includes a frame 112 which may serve to support other components of the log splitter 100. The frame 112 may also have a lip 114 which may secure the log splitter 100 in a fixed position. For example, the lip 114 may serve to maintain the log splitter 100 in a fixed position as logs are forced through the stages.

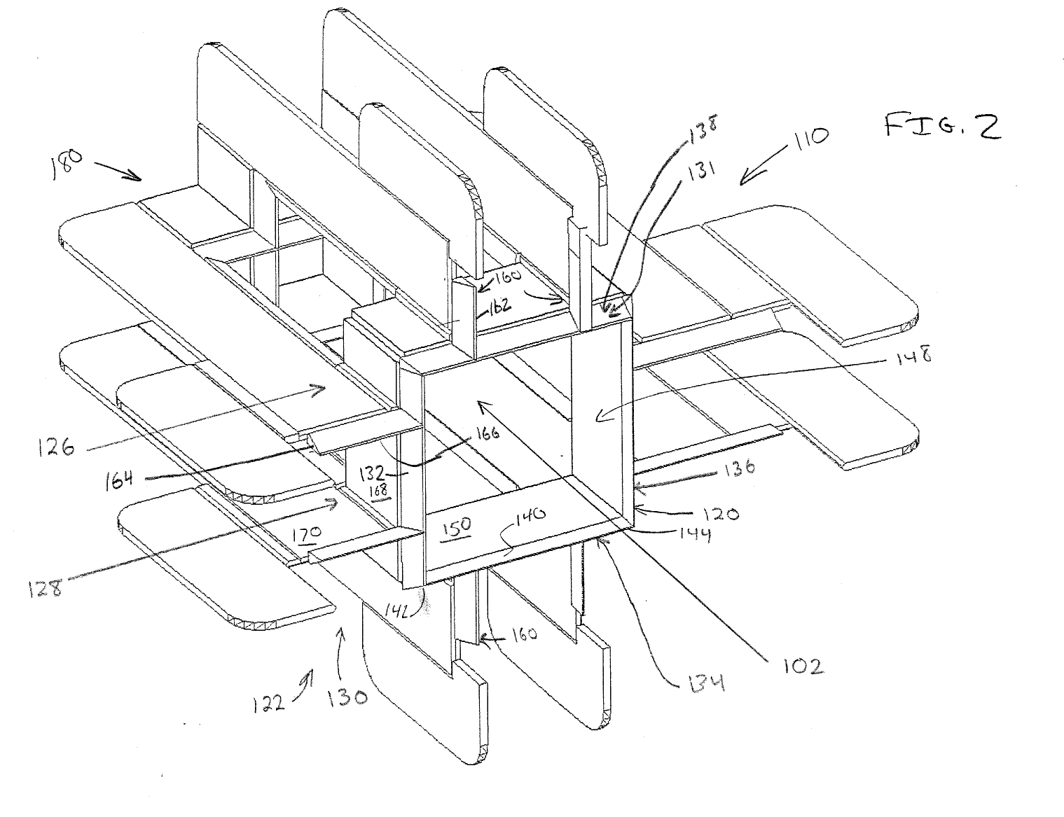

As described in greater detail below, the first stage 110 has a plurality of ports wherein the boundaries of the ports serve to cut or split logs. FIG. 2 is a view of the first stage 110 with the frame 112 removed. As shown, the first stage 110 has a first port 120, which may be located substantially in the center of the first stage 110. The first port 120 is shown as being substantially square. However, the first port may be virtually an shape. A plurality of secondary ports 122 are located around the periphery of the first port 120. Three secondary ports are described and identified individually as the first secondary port 126, the second secondary port 128, and the third secondary port 130. As logs are passed through the first stage 110, the first port 120 causes the center of the log to be split to an elongated square shape. The secondary ports 122 split the remaining portions of the log. The first port 120 and the secondary ports 122 are sometimes referred to as having first sides and second sides, wherein logs enter the first sides and exit the second sides.

The first port 120 has a plurality of blades 131 located around its periphery. The blades 131 described herein are referred to individually as the first blade 132, the second blade 134, the third blade 136, and the fourth blade 138. Referring to the second blade 134, which illustrative of all the blades 131, the second blade 134 has a first surface 140, a second surface 142, and an edge 144. The first surface 140 and the second surface 142 are on different planes that intersect, which forms the edge 144. The edge 144 serves to split the logs as described herein. The configuration of the first surface 140 and the second surface 142 cause the second blade 134 to be tapered, which forces portions of the logs into the secondary ports 122.

As described above, logs pass through the log splitter 100 and the first stage 110 in a direction 102 from the first surface to the second surface. The above described plane of the first surface 140 of the second blade 134 may be substantially parallel to the direction 102. Thus, the second blade 134 and the remaining blades 131 taper via the second surface 142. The second surface 142, or taper, causes portions of the log that are split by the second blade 134 to pass through the secondary ports 122.

The first port 120 has interior surfaces 148 that define the first port 120. Reference is made to a second interior surface 150 that is similar to all the interior surfaces 148. In addition, reference is made to the relation between the second interior surface 148 and the second blade 140, which is similar to the relation to all the blades 131 and their corresponding interior surfaces 148. The plane of the first surface 140 of the second blade 134 may be located on a different plane as the second interior surface 150. However, the planes may be substantially parallel. This location of the second blade 134 relative to the second interior surface 150 causes the first surface 140 of the second blade 134 to be offset from the second interior surface. Thus, circumference of the first port defined by the interior surfaces 148 may be greater than the circumference of the opening defined by the first surfaces 140 of the blades 131. Therefore, when a log is forced through the first stage 110, it is split by the blades 131 and continues to pass through the first stage 110. Because the interior circumference is greater than the exterior circumference (circumference of the blades 131), the log has a reduced chance of jamming as is passes through the first stage 110.

As shown in FIG. 2, the secondary ports 122 are at least partially surrounded by secondary blades 160. The first secondary port 126 is closed on two sides and has a first secondary blade 162 and a second secondary blade 164 located on the closed sides. The first secondary port 126 has a corner that is the intersection of the first blade 132 and the fourth blade 138. It is noted that the configuration of the first secondary port 126 is substantially similar to the remaining secondary ports located on the corners of the first stage 110. The blades 162, 164 are tapered in a direction to force sections of the log to be diverted away from the first stage 110. The taper is sometimes referred to as being in or toward the secondary port 126. This diversion occurs because the first secondary port 122 only has two sides, so log portions cannot get stuck therein.

The second secondary port 126 is similar to the secondary ports located on the side of the first port 120. The second secondary port 126 has three interior surfaces, which are referred to as the first interior surface 166, the second interior surface 168, and the third interior surface 170. The first interior surface 166 is associated with the second secondary blade 164 and the third interior 170 surface is associated with a third secondary blade 174. The second interior surface 168 is associated with the first blade 132 of the first port 120.

The first blade 132 is tapered as described above to force a portion of a log into the second secondary port 128. The portion of the log forced through the second secondary port 128 is split by the second secondary blade 164 and the third secondary blade 174. It is noted that the first surfaces 140 of the secondary blades 164, 174 are offset from their respective interior surfaces 166, 170. As with the first port 120, the offset reduces the likelihood that logs will get stuck in the second secondary port 128 and the similar secondary ports.

Having described the first stage 110, the second stage 180 of the log splitter will now be described. The second stage receives the portion of the log that has passed through the first port 120. In the embodiment of FIGS. 1 and 2, the log entering the second stage 180 will be substantially square. For example, the log may be fourteen inches on each side, but may have a longer length. In some embodiments, the second stage 180 is a substantially similar, but smaller version of the first stage 110.

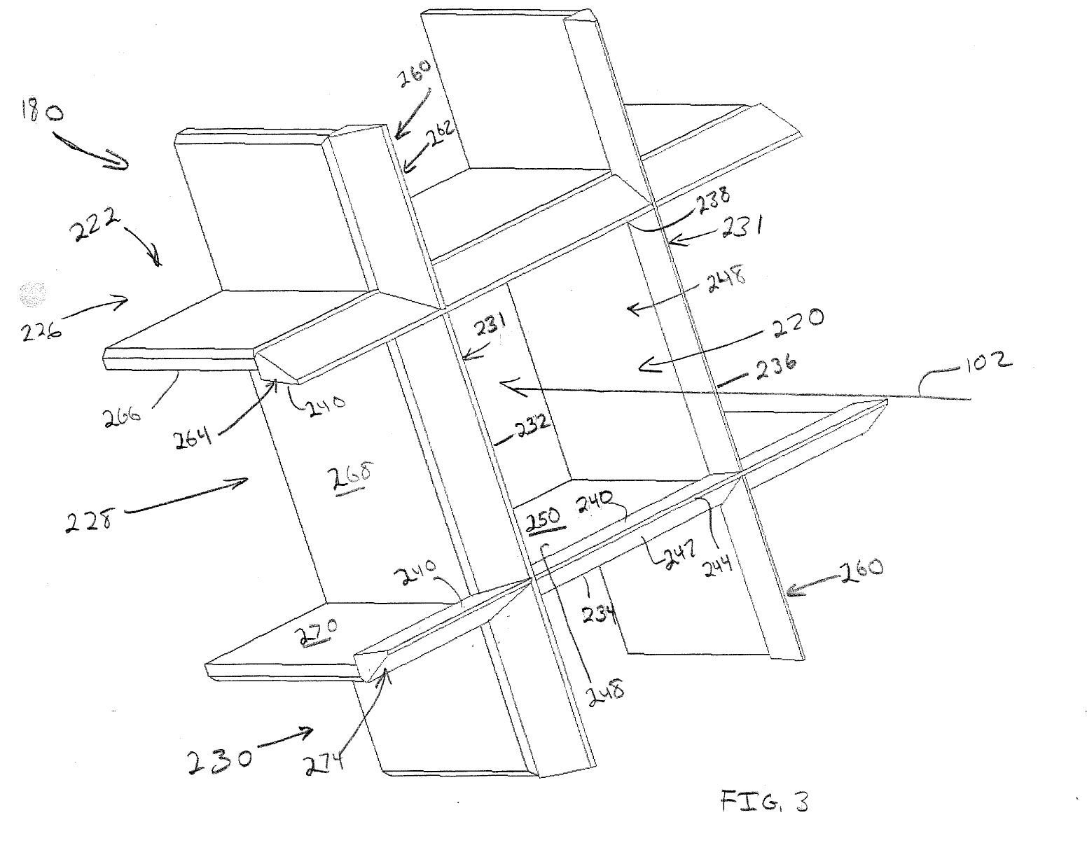

With additional reference to FIG. 3, the second stage 180 may have a second port 220 that may be half the size of the first port 120. For example, the second port 220 may be seven inches by seven inches. The second port 220 is shown as being substantially square. However, the second port 220 may be virtually an shape. A plurality of secondary ports 222 are located around the periphery of the second port 220. The second port 220 and the secondary ports 222 have first and second sides wherein logs enter the first sides and exit the second sides. Three secondary ports 222 are described and identified individually as the first secondary port 226, the second secondary port 228, and the third secondary port 230. As logs are passed through the second stage 180, the second port 220 causes the center of the log to be split to an elongated square shape. The secondary ports 122 split the remaining portions of the log. It is noted that the second stage 180 may be the same size as the opening of the first port 120, which may be approximately fourteen by fourteen inches.

The second port 220 has a plurality of blades 231 located around its periphery, which are substantially similar or identical to the blades 131. The blades 231 described herein are referred to individually as the first blade 232, the second blade 234, the third blade 236, and the fourth blade 238. Referring to the second blade 234, which illustrative of all the blades 231, the second blade 234 has a first surface 240, a second surface 242, and an edge 244. The first surface 240 and the second surface 242 are on different planes that intersect, which forms the edge 244. The edge 244 serves to split the logs as described herein.

As described above, logs pass through the log splitter 100 and the second stage 180 in a direction 102. The above described plane of the first surface 240 of the second blade 234 may be substantially parallel to the direction 202. Thus, the second blade 234 and the remaining blades 231 taper via the second surface 242. The second surface 242 causes portions of the log that are split by the second blade 234 to pass through the secondary ports 222. It is noted that the blades 231 associated with the second port 220 function substantially similar to the blades 131 of the first port 120.

The second port 220 has interior surfaces 248 that define the second port 220. Reference is made to a second interior surface 250 that is similar to all the interior surfaces 248. In addition, reference is made to the relation between the second interior surface 248 and the second blade 234, which is similar to the relation to all the blades 231 and their corresponding interior surfaces 248. The plane of the first surface 240 of the second blade 234 may be located on a different plane as the second interior surface 250. However, the planes may be substantially parallel. This location of the second blade 234 relative to the second interior surface 250 causes the first surface 240 of the second blade 234 to be offset from the second interior surface. Thus, circumference of the first port 220 defined by the interior surfaces 248 may be greater than the circumference of the opening defined by the first surfaces 240 of the blades 231. Therefore, when a log is forced through the second stage 180, it is split by the blades 231 and continues to pass through the second stage 180. Because the interior circumference is greater than the exterior circumference (circumference of the blades 231), the log has a reduced chance of jamming as is passes through the second stage 180.

As shown in FIG. 3, the secondary ports 222 are at least partially surrounded by secondary blades 260. The first secondary port 226 is closed on two sides by a first secondary blade 262 and a second secondary blade 264. It is noted that the configuration of the first secondary port 226 is substantially similar to the remaining secondary ports located on the corners of the second stage 180. The blades 262, 264 are tapered in a direction to force sections of the log to be diverted away from the second stage 180. This diversion occurs because the first secondary port 226 only has two sides, so log portions cannot get stuck therein.

The second secondary port 226 is similar to the secondary ports located on the side of the second port 220. It is also similar to the side secondary ports on the first stage 110. The second secondary port 226 has three interior surfaces, which are referred to as the first interior surface 266, the second interior surface 268, and the third interior surface 270. The first interior surface 266 is associated with the second secondary blade 264 and the third interior 270 surface is associated with a third secondary blade 274. The second secondary blade 264 may be an extension of the fourth blade 238 and may be tapered in the same direction as the fourth blade 238. The third secondary blade 274 may be an extension of the second blade 234 and may be tapered in the same direction as the second blade 234. The second interior surface 268 is associated with the first blade 232 of the second port 220.

The first blade 232 is tapered as described above to force a portion of a log into the second secondary port 228. The portion of the log forced through the second secondary port 228 is split by the second secondary blade 264 and the third secondary blade 274. It is noted that the first surfaces 240 of the secondary blades 264, 274 are offset from their respective interior surfaces 266, 270. As with the second port 220, the offset reduces the likelihood that logs will get stuck in the second secondary port 228 and the similar secondary ports.

The log splitter 100 described herein has a third stage 300 that further splits logs that have passed through the second stage 180. The third stage has four blades 310 that split the log into quarters. The log portions are then discharged from the splitter 100, so the blades 310 do not need to be tapered.

Having described the components of the splitter 100, its operation will now be disclosed. Referring to FIG. 1, the frame 112 is supported relative to a mechanism, such as a hydraulic piston that forces logs through the splitter 100. A log is placed against the first stage 110. The above-described mechanism then forces the log through the first stage 110.

If the log is large enough to contact all nine ports of the first stage 110, it will be split into nine portions. The portion passing through the first port 110 will be substantially square and will pass through to the second stage 180. The portions of the log that pass through the secondary ports 122 will be discharged or may fall away from the splitter 100. The blades 131 on the first port 120 are tapered, so as to cause the log portions being split to pass into the secondary ports 122. The space between the blades 131 and the interior surfaces 148 of the first port 120 causes the portion of the log passing through the first port 120 to be slightly smaller than the first port 120. This size difference prevents the log portion passing through the first port 120 from getting stuck therein.

At this point, the original log has been split to a center portion that passed through the first port 120 and eight other portions that passed through the secondary ports 122. The center section is then passed through the second stage 180. The second stage 180 is approximately the size of the first port 120. The log is split again into a center portion that passes through the second port 220 and eight other portions that pass through the secondary ports 222. The center portion is then passed through the third stage 300 where it is spit again. In the embodiment described above, the third stage 300 splits the log into quarters. However, the third stage 300 could split the log into halves or thirds.

What is claimed is:

1. A log splitter comprising:
a first stage comprising:
a first port having a first port first end and a first port second end, wherein logs enter said first port first end and exit said first port second end;
a first blade located on at least a portion of said first port first end, said first blade having a first surface and a second surface, wherein a plane of said first surface and a plane of said second surface intersect proximate said first port first end, said first surface being substantially parallel to the direction of logs through said first port.

2. The log splitter of claim 1 wherein said first stage further comprises:
at least one first secondary port located adjacent said first port, said at least one first secondary port comprising:
a first side, wherein said second surface of said first blade is located proximate said first side;
a second side having a second blade located thereon.

3. The log splitter of claim 1, wherein said second blade is tapered, wherein the taper extends away from said at least one secondary port.

4. The log splitter of claim 2, wherein said at least one secondary port comprises a third blade, said third blade being tapered, wherein the taper extends away from said at least one secondary port.

5. The log splitter of claim 2, wherein the area of said first port is greater than the area of said at least one secondary port.

6. The log splitter of claim 1 wherein said first stage further comprises at least one second secondary port located adjacent said first port, said at least one second secondary port being adjacent two blades of said first port.

7. The log splitter of claim 1, wherein said first port has at least one interior surface located proximate said first blade, wherein said first surface of said blade is located closer to the center of said first port than said interior surface.

8. The log splitter of clam 1 and further comprising a second stage, wherein logs exiting said first stage enter said second stage, said second stage comprising:
a first port having a first port first end and a first port second end, wherein logs enter said first port first end and exit said first port second end;
a first blade located on at least a portion of said first port first end, said first blade having a first surface and a second surface, wherein a plane of said first surface and a plane of said second surface intersect proximate said first port first end, said first surface being substantially parallel to the direction of logs through said first port.

9. The log splitter of claim 1 and further comprising a third stage, said third stage comprising at least one blade, wherein logs entering said third stage are split by said at least one blade.

10. The log splitter of claim 9, wherein said at least one blade comprises a first blade that intersects a second blade.

11. The log splitter of claim 1, wherein said first port is substantially square and has dimension of approximately fourteen inches by fourteen inches.

12. A log splitter comprising:
a first stage comprising:
a first port having a first port first end and a first port second end, wherein logs enter said first port first end and exit said first port second end;
a first blade located on at least a portion of said first port first end, said first blade having a first surface and a second surface, wherein a plane of said first surface and a plane of said second surface intersect proximate said first port first end, said first surface being substantially parallel to the direction of logs through said first port;
a second stage comprising:
a first port having a first port first end and a first port second end, wherein logs enter said first port first end from said first port second end of said first stage;
a first blade located on at least a portion of said first port first end, said first blade having a first surface and a second surface, wherein a plane of said first surface and a plane of said second surface intersect proximate said first port first end, said first surface being substantially parallel to the direction of logs through said first port.

13. The log splitter of claim 12 and further comprising a third stage, said third stage comprising at least one blade, wherein logs entering said third stage from said second stage are split by said at least one blade.

14. The log splitter of claim 13, wherein said at least one blade comprises a first blade that intersects a second blade.

15. The log splitter of claim 12 wherein said first stage further comprises at least one second secondary port located adjacent said first port, said at least one second secondary port being adjacent two blades of said first port.

16. The log splitter of claim 15, wherein the area of said first port of said first stage is greater than the area of said at least one secondary port of said first stage.

17. The log splitter of claim 12, wherein said first port of said first stage has at least one interior surface located proximate said first blade, wherein said first surface of said blade is located closer to the center of said first port than said interior surface.

18. The log splitter of claim 12, wherein said first port of said second stage has at least one interior surface located proximate said first blade, wherein said first surface of said blade is located closer to the center of said first port than said interior surface.

19. The log splitter of claim 12, wherein the area of said first port of said first stage is greater than the area of said first port of said second stage.

20. The log splitter of claim 12, wherein said first blades are tapered from said first ports to force split sections of logs away from said first ports.
